(19) United States
(12) Patent Application Publication
(10) Pub. No.: US 2006/0069763 A1
(43) Pub. Date: Mar. 30, 2006

(54) Queue management device

(75) Inventor: Toshiharu Kido, Nagoya (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/024,735

(22) Filed: Dec. 30, 2004

(30) Foreign Application Priority Data
Sep. 2, 2004 (JP) 2004-256130

(51) Int. Cl. G06F 15/173

(52) U.S. Cl. 709/223

(57) ABSTRACT

To make it possible to restrain a load of a server by setting a request in a standby status when the server has a high load and to restrain a halt of the request. A load of a server for providing a service in response to request information given from an information device is monitored, the server is notified of, when receiving the request information from the information device, the request information if it proves from a result of monitoring that the load meets a predetermined condition, and, whereas if the load does not meet the predetermined condition, information about the information device is added to a queue while holding the request information, the information device added to the queue is notified of issuing an incentive corresponding to waiting time, the information device and the incentive are stored in a way that associates the information device and the incentive with each other, if it proves from the result of monitoring that anew request is acceptable, the information about the information device is excluded from the queue in a predetermined order, and the server is notified of the request information given from the information device.

### BACKGROUND OF THE INVENTION

The invention relates to a technology of setting a request given to a server in a standby status in accordance with a load of the server for providing a service via a network.

With the spread of the Internet over the recent years, various categories of services have been provided by utilizing WWW (World Wide Web that will hereinafter be also termed Web).

Particularly in the field of a so-called E-commerce, there is a merit that transactions can be conducted without being restricted in terms of time and place as compared with real shops, and an extensive tendency thereof is seen.

In this type of E-commerce, campaigns or the like were performed in order to raise sales by increasing accesses.

When performing a highly-effective campaign, however, the accesses are concentrated at one point of time of starting the campaign, resulting in a high-load state. If this load becomes excessively high, a function of a server gets declined enough to make it difficult to utilize the server, which might lead to a decrease in sales.

On the other hand, it is considered to strengthen the equipment capable of accepting the accesses when starting the campaign. If adapted to this kind of transient accesses, however, the equipment comes to have a redundant construction, which induces a rise of futile cost.

Proposed, therefore, are a variety of devices constructed such that when the load rises as the requests given to the server increase, the load is controlled by setting the requests to the server in the standby status.

[Patent document 1]

Japanese Patent Application Laid-Open No. 2002-82906

[Patent document 2]

Japanese Patent Application Laid-Open No. 2003-122712

[Patent document 3]

Japanese Patent Application Laid-Open No. 2001-265693

[Patent document 4]

Japanese Patent Application Laid-Open No. 2003-303171

[Patent document 5]

Japanese Patent Application Laid-Open No. 2002-163404

[Patent document 6]

Japanese Patent Application Laid-Open No. 2001-265878

[Patent document 7]

Japanese Patent Application Laid-Open No. 2001-249988

### SUMMARY OF THE INVENTION

Such simple on-standby requests to the server, however, cause a problem, wherein clients making the requests come to decrease in their eagerness to buy as waiting time elongates, with the result that the clients get irresistible to waiting and halt the requests.

For example, in the case of displaying the number of waiting clients and the waiting time, if the number of waiting clients is extremely large or if the waiting time is extremely long, there arises a problem that the clients give up their requests and can not, though the load of the server is reduced, be introduced into the service.

Such being the case, the invention provides a technology capable of restraining both the load of the server and a halt of the requests by setting the requests in the standby status when the server has the high load and by issuing an incentive corresponding to this standby time.

The invention adopts the following constructions in order to solve the problems. Namely, in a queue management device, a queue management method, a queue management program and a Web system according to the invention,
a load of a server for providing a service in response to request information given from an information device is monitored,
the server is notified of, when receiving the request information from the information device, the request information if it proves from a result of monitoring that the load meets a predetermined condition, and, whereas if the load does not meet the predetermined condition, information about the information device is added to a queue while holding the request information,
the information device added to the queue is notified of issuing an incentive corresponding to waiting time, and the information device and the incentive are stored in a way that associates the information device and the incentive with each other, and
if it proves from the result of monitoring that a new request is acceptable, the information about the information device is excluded from the queue in a predetermined order, and the server is notified of the request information given from the information device.

It should be noted that the incentive may be a point, a discount or a coupon, which are usable in the service provided from the server.

Further, according to the invention, the information device added to the queue may be notified of the waiting time and/or a waiting device count in accordance with the result of monitoring.

There may be further executed a step of providing a queue-oriented content to the information device added to the queue from the storage module stored with the queue-oriented content having a load lighter than that of the service provided by the server.

When notifying the information device of a guide of a Web site provided by the server as the queue-oriented content and receiving the request information based on the guide from the information device, the server may be notified of the request information based on the guide as a substitute for the on-hold request information on the occasion of excluding the information device from the queue.

The invention makes it possible to restrain the load of the server by setting the requests in the standby status when the server has the high load and to restrain the halt of the requests.

### DESCRIPTION OF THE DRAWINGS

FIG. 1 is a diagram of an outline of architecture of a Web system according to the invention.

FIG. 2 is an explanatory flowchart of a queue management method according to the invention.

FIG. 3 is an explanatory flowchart of the queue management method according to the invention.

FIG. 4 is an explanatory diagram of a page showing a purport of being congested.

FIG. 5 is a diagram showing an example of a standby page.

FIG. 6 is a diagram showing an example of the standby page.

FIG. 7 is an explanatory diagram of a page showing permission to enter a net shop.

FIG. 8 is a diagram showing an example of a top page of the net shop.

FIG. 9 is an explanatory diagram of a queue DB.

FIG. 10 is an explanatory diagram of an applied campaign number.

FIG. 11 is an explanatory diagram of an incentive application method.

FIG. 12 is an explanatory diagram of a cart DB.

### DETAILED DESCRIPTION OF THE INVENTION

A best mode for carrying out the invention will hereinafter be described with reference to the drawings. A configuration in the following embodiment is an exemplification, and the invention is not limited to this configuration in the embodiment.

§1. Whole Architecture

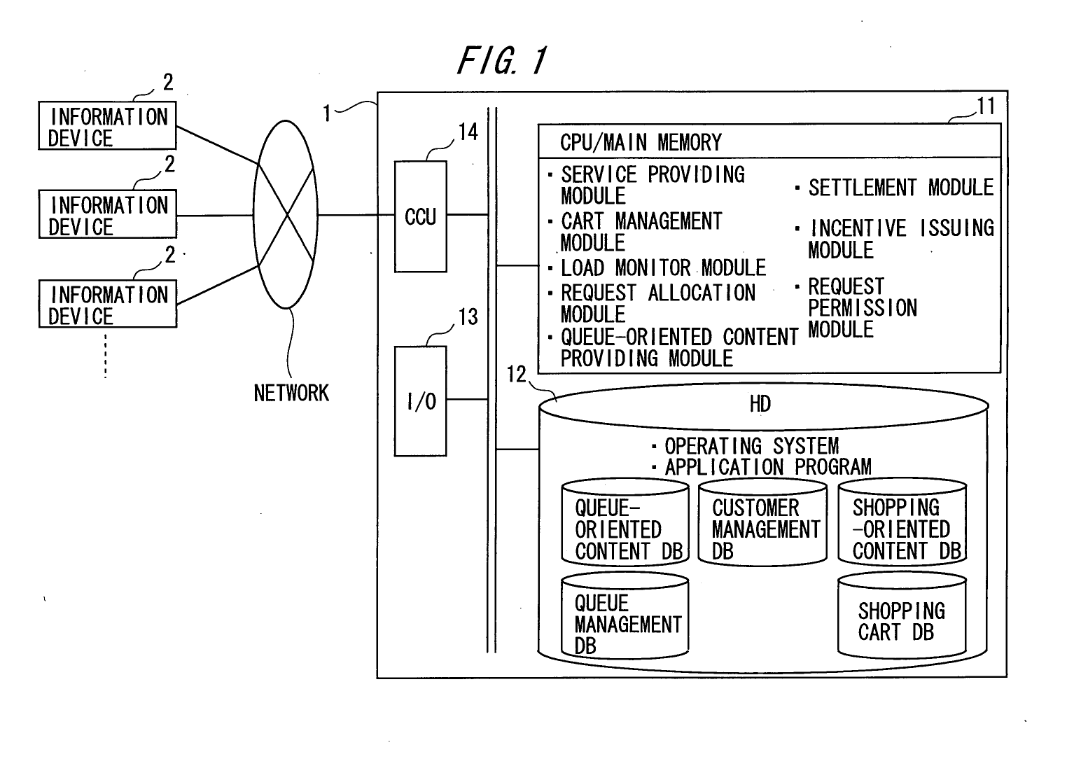

FIG. 1 is a diagram of an outline of architecture of a Web system 1 according to the invention.

The Web system 1 in this example administers a so-called net shop for conducting services for selling commercial articles on a network, and provides (transmits), when receiving request information from an information device (client terminal) 2 via a network such as the Internet, etc., a service corresponding to this request information to the information device. For example, when the client requests the Web system 1 for a top page of the net shop by operating the information device 2, the Web system 1 transmits information (HTML (HyperText Markup Language) file, etc.) of this top page to the information device 2. On the other hand, the information device 2 receives and displays the top page on a display. Then, when the client performs operations such as searching through commercial articles, putting a desired commercial article into a cart, then settling an account and so on, the information device 2 transmits this request information to the Web system 1. The Web system 1 provides a service such as extracting pieces of commercial article information corresponding to this request information from a shopping-oriented content DB (Database) and providing the information, registering a shopping cart DB with the information about the commercial article put into the cart, settling an account of this commercial article, and so forth.

Further, the Web system 1 in the embodiment includes a function as a server for providing a variety of services and a function as a queue management device for controlling a load of the server.

§2. Constructions of Respective Units

The web system 1 in the embodiment is a general type of computer (information processing device) constructed of an arithmetic processing unit 11 built up by a CPU and a memory, a storage unit (hard disk, etc.) 12, an input/output (I/O) unit 13, a communication control unit (CCU) 14 and so forth.

An input device such as a keyboard, a mouse, etc., a display device and an output device such as a printer, etc. are properly connected to the I/O unit 13.

The storage unit 12 is stored with an operating system (OS) and application programs (a queue management program, a cart management program, a content management program, and a settlement management program). Further, the storage unit 12 includes a queue management database (DB), a queue-oriented content DB, a shopping-oriented content DB, a shopping cart DB and a customer management DB.

The arithmetic processing unit 11 properly reads the OS and the application programs from the storage unit 12 and executes the OS and the programs, and executes arithmetic processes about pieces of information inputted from the I/O unit 13 and the CCU 14 and pieces of information read from the databases, thereby actualizing functions as a service providing module, a cart management module, a settlement module, a load monitor module, a request allocation module, an incentive issuing module, a request permission module and a queue-oriented content providing module.

The service providing module extracts a content corresponding to the request information of the information device 2 from the shopping-oriented content DB and provides the extracted content to the information device 2.

The cart management module manages the cart information in a way that registers the cart information for every information device 2 on the shopping cart DB.

The settlement module, when the client has decided to purchase, reads the cart information and settles an account of the selected commercial article.

The load monitor module monitors a load of the Web system (server) 1. In this example, the load monitor module monitors the number of the information devices (clients) receiving the service, i.e., a load, by counting the number of carts generated for every information device.

The request allocation module, if it proves from a result of monitoring that the load meets a predetermined condition (e.g., the cart count (the number of carts) is less than a predetermined value in this example) when receiving the request information from the information device 2, notifies the server of the request information. Whereas if the load does not meet the predetermined condition (if the cart count is larger than or equal to the predetermined value), the request allocation module holds the request information and registers the information of the information device 2 on the queue management DB, thus adding the information device 2 to the queue.

The incentive issuing module notifies the information device 2 added to the queue, of issuing an incentive corresponding to queuing time, and stores the customer management DB with this information device 2 and the incentive in a way that associates the information device 2 and the incentive with each other.

The request permission module, if it proves from the result of monitoring that the cart count comes to meet the predetermined condition as in the case of the information device's exit from the site which has finished shopping and so on, judges that a new request is acceptable, then excludes the information of the information device from the queue in a predetermined order, and notifies the server of the request information from the information device.

In the system 1 in the embodiment, the service providing module, the cart management module, the settlement module, the shopping-oriented content DB, the shopping cart DB, the customer management DB, etc. correspond to the server for providing the service to the information device 2, and the load monitor module, the request allocation module, the incentive issuing module, the request permission module, the queue-oriented content providing module, the queue management DB, the queue-oriented content DB, etc. correspond to the queue management device. It should be noted that the server and the queue management device are constructed integrally as described above in the embodiment and may also be constructed as separate devices.

§3. Queue Management Method

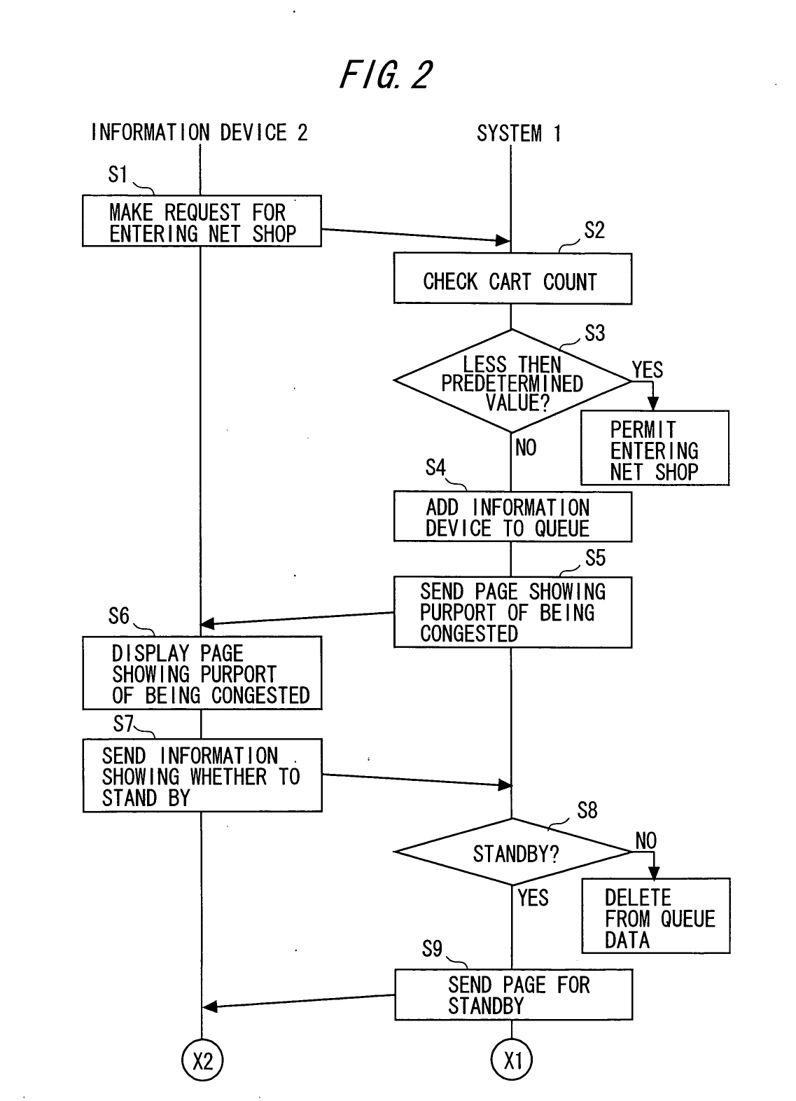

FIG. 2 is an explanatory flowchart of a queue management procedure (method) when the server has a high load.

The information device 2 is stored with customer information through which the system 1 can recognize the customer, such as a customer ID generated when this information device 2 previously gained an access to the system 1.

To begin with, when the information device 2 accesses the system 1, the system 1 requests the information device 2 to send the customer information. The information device 2, when having the customer information requested, sends this customer information to the system 1. The information device 2, if there is no customer information, generates the customer information afresh and sends the customer information to the system 1.

Through this customer information, the system 1 can identify the information device 2. This type of customer information is called Cookie, which has already been utilized for a multiplicity of network services.

After the system 1 has recognized the information device through the customer information, the information device 2, when executing a process of entering the net shop, requests the system 1 for the top page of the net shop (step 1, which will hereinafter also be abbreviated to S1 for convenience).

The system having received this request information checks a cart count by the function as the load monitor module (S2). The request allocation module, if this cart count is less than a predetermined count, permits the client to enter the net shop and notifies the service providing module of the request information (S3, S100). If the cart count is larger than or equal to the predetermined count, the request allocation module judges that the load is high, then holds the request (temporarily stores (caches) the request on the memory, etc.), and adds the information device to the queue (S3-S4). Namely, the request allocation module generates a unique ID for every information device and registers the queue DB with the ID together with information, etc. of a campaign to be applied.

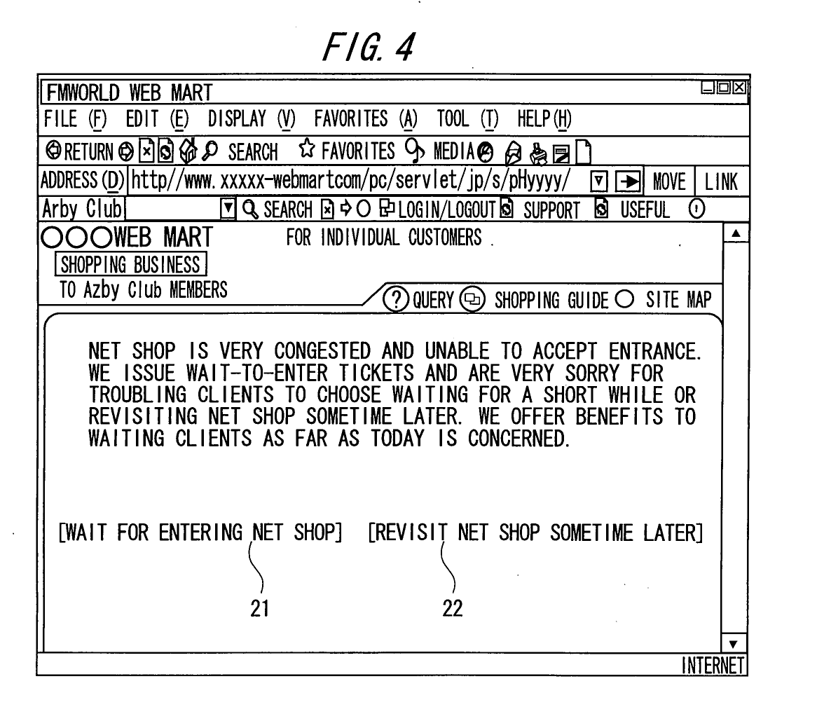

Then, the queue-oriented content providing module, with the unique ID serving as Cookie for managing a session, sends the ID together with a page showing a purport of being congested as shown in FIG. 4 to the information device 2 (S5).

The information device 2 having received this page displays this page on the display by a function of Web Browser, etc. (S6). When the client selects (clicks) [wait for entering the net shop] 21 or [revisit the net shop sometime later] 22 in this page, the information device 2 transmits information indicating whether it stands by or not to the system 1 (S7).

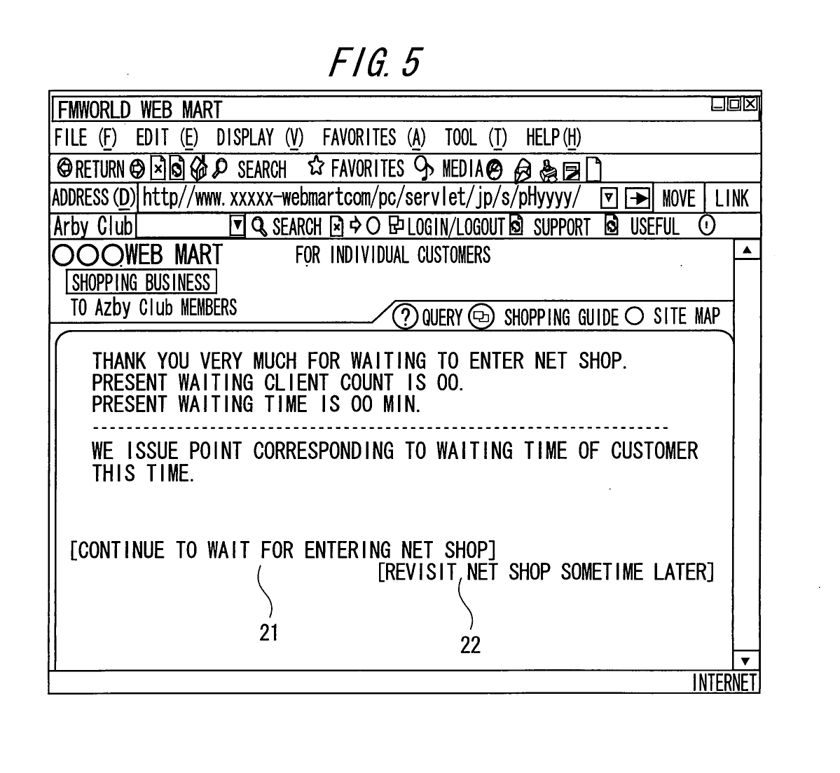

In response to this, the system 1, when [revisit the net shop sometime later] 22 is selected, deletes the information of the information device 2 from the queue DB (S8, S101). When [wait for entering the net shop] 21 is selected, the system 1 sends a standby page shown in FIG. 5 (S9). The standby page describes a present waiting device count (the number of the devices registered on the queue DB before this information device) and present waiting time (which is 0 min because of an initial status) Further, this standby page contains a JAVA (registered trademark) Script, wherein the page is updated at an interval of a predetermined period of time (30 sec in this example).

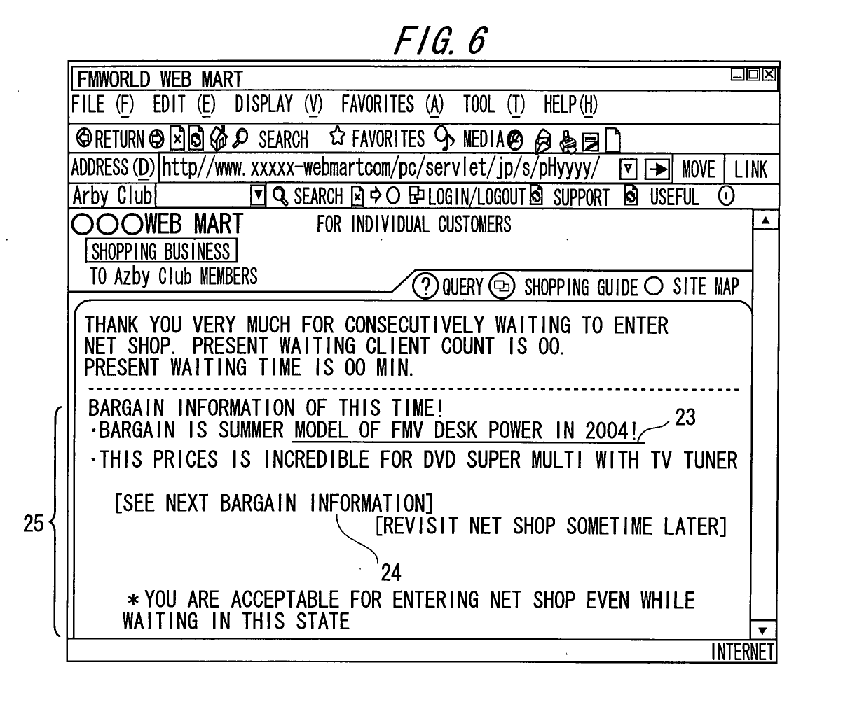

With this operation, when the information device 2 notifies the system 1 of updating (S10), the system 1 checks the cart count by the function of the load monitor module (S11), and checks whether the request is acceptable or not by the function of the request permission module (S12). To be specific, the request permission module checks whether a count obtained by adding the cart count to the waiting device count is less than a predetermined count or not. The request permission module, if not less than the predetermined count, obtains the waiting time from waiting time data creation date/time and the present time, then registers the waiting time on the queue DB, and sends the standby page containing the updated waiting time and waiting device count to the information device 2 (S13). Note that a standby content 25 may also be described by way of this standby page as shown in FIG. 6.

As this standby content 25, contents each exhibiting a light load as compared with the shopping-oriented contents are chosen beforehand and stored on the standby content DB. Bargain information, a shopping guide, a site menu, etc. are exemplified in the embodiment. In these contents, the information of the page responding to the request is simply transmitted, and hence the content may be lighter in load for providing than a content involving processes of searching the database and reorganizing the page as in the case of BTO (Build to order).

Moreover, these standby content can be requested by selecting links such as [see next bargain information] 24, a site map 25 and a shopping guide 26 in this page. Further, when selecting a link 23 to the shopping-oriented content described in this page, the system 1 stores the memory with this request as a substitute for the on-hold request.

With this scheme, the system 1, when permitting the client to enter the net shop, directly transmits not the top page but a page to which this link is hyperlinked, thereby enabling both an omission of such a process that the client searches for this page from the top page and a further reduction in load.

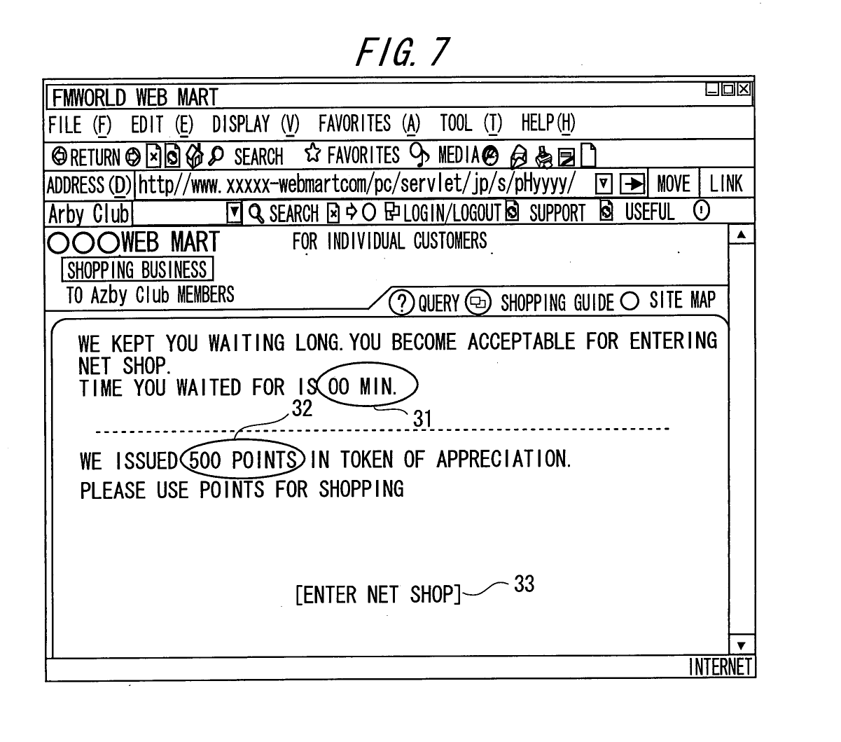

On the other hand, if the count obtained by adding the cart count to the waiting device count is less than the predetermined count in step 12, the system 1 permits the client to enter the net shop and sends the page showing the permission to enter the net shop in FIG. 7 (S14). At this time, the request permission module reads the queue data of the information device from the queue DB, acquires an incentive to be issued from this waiting time and a campaign number, and describes waiting time 31 and an incentive (of which a point is 500p in the example in FIG. 7) 32 on the page.

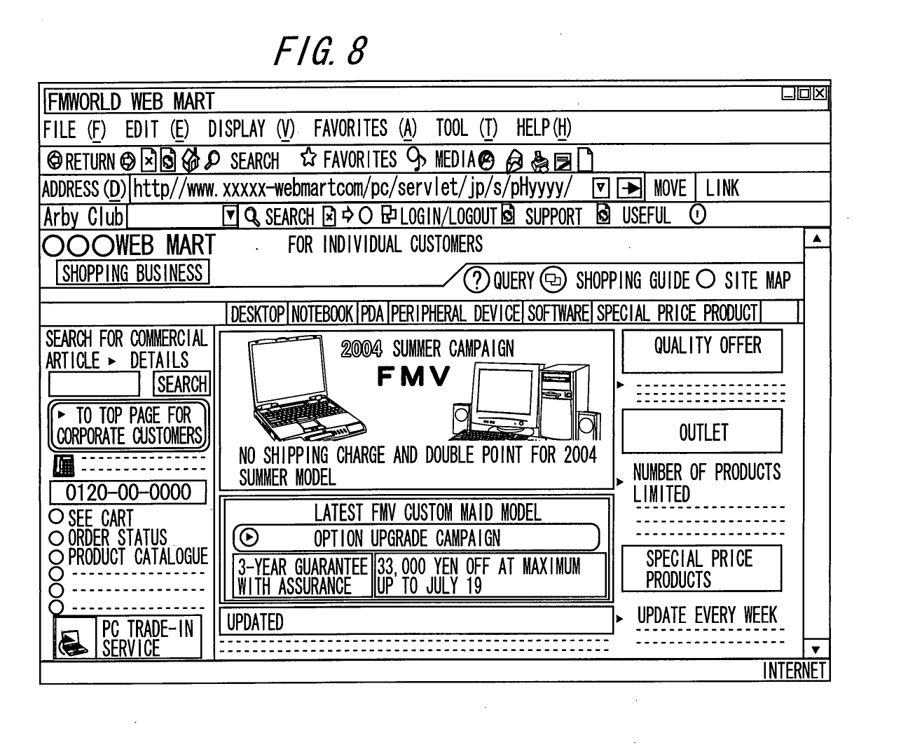

When selects [enter the net shop] 33 on this page and the information device 2 notifies of this request information (S15), the system 1 notifies the service providing module of the on-hold request information. The service providing module creates cart information of this information device 2, and registers the shopping cart DB with the cart information together with the waiting time and the campaign number in the queue data (S16). The service providing module, with a cart information ID used as Cookie, transmits the cart information together with the page corresponding to the request information to the information device 2. FIG. 8 shows an example of the top page transmitted in response to the request.

The client repeats the requests such as searching for the commercial article, selecting the option from this top page and so on, and puts a want-to-purchase commercial article into the cart. To be specific, the system 1 transmits the page responding to the request, and registers the shopping cart DB with the information of the commercial article receiving the indication to be put into the cart. Thus, the net shopping service is provided in a way that repeats providing the Web pages, etc. responding to the requests from the information devices 2.

Then, when the information device 2 decides to purchase and notifies the system of this purchase, the settlement module of the system 1 executes a settlement process such as reading the cart information of the information device 2 from the shopping cart DB, and registering the customer management DB with this commercial article information together with a payment method concerning a credit car, electronic money, utilization of points, etc. (S18). At this time, the settlement module confirms the waiting time and the campaign number in the cart information, and determines a transaction condition about an amount of money for the purchase, etc. by applying the incentives such as a discount, a coupon, the point, etc.

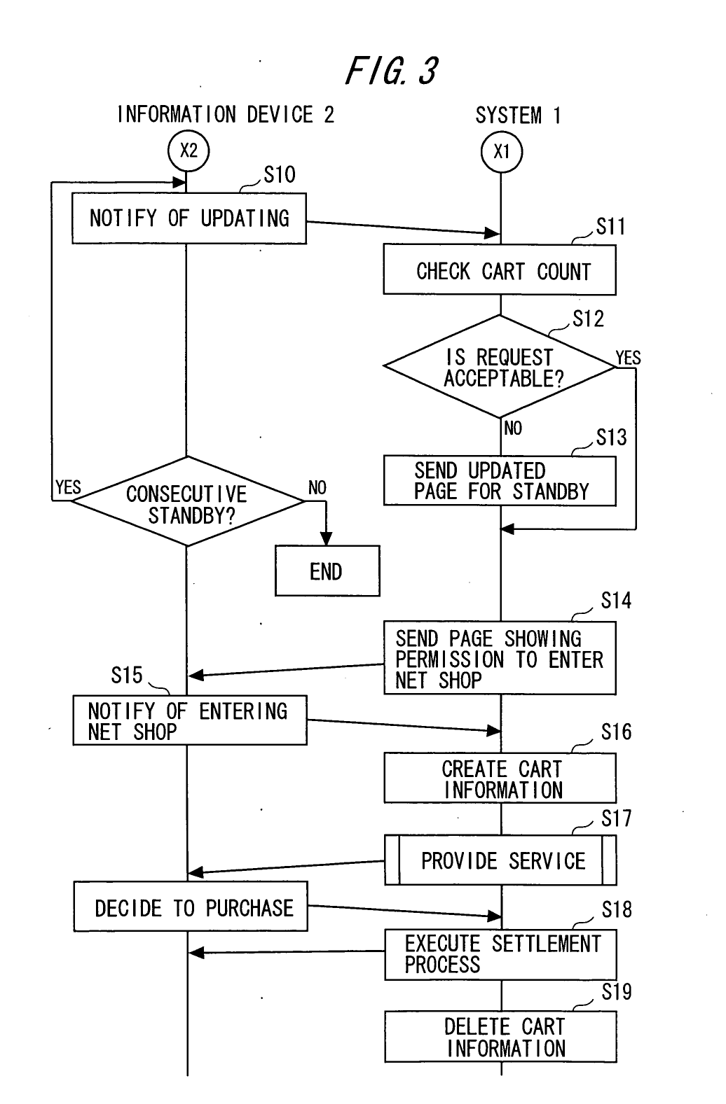

When the settlement is completed, the system 1 deletes the cart information of the information device 2 (S19). It is to be noted that the cart information is also deleted, though omitted in FIGS. 2 and 3, if there is no access to the system 1 over a predetermined period of time without settling the account after entering the net shop and if there is no request for a predetermined period of time.

Note that if decided to give up entering the net shop during a standby status and if any incentive is not utilized by having no access to the system 1 over the predetermined period of time without purchasing anything after entering the net shop, this may be invalidated, or there may be taken such a scheme that the incentive information is stored together with the information device identifying information such as the customer information, the membership number, etc. on the customer DB, and the incentive information can be utilized by inputting the customer information, the membership number, etc when gaining the access from next time onward.

§4. Details of Database

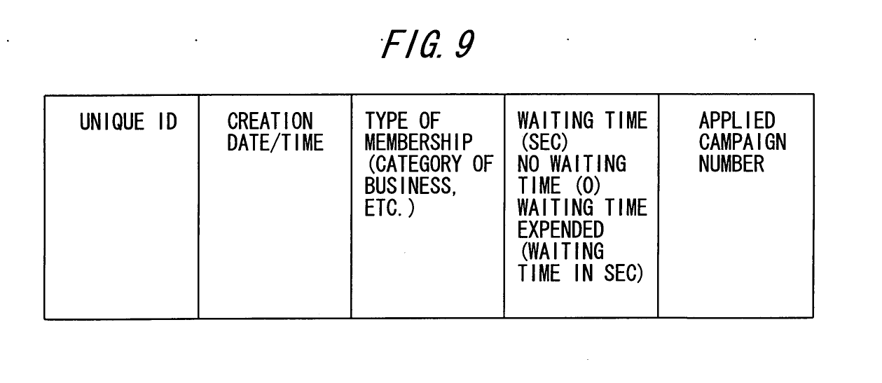

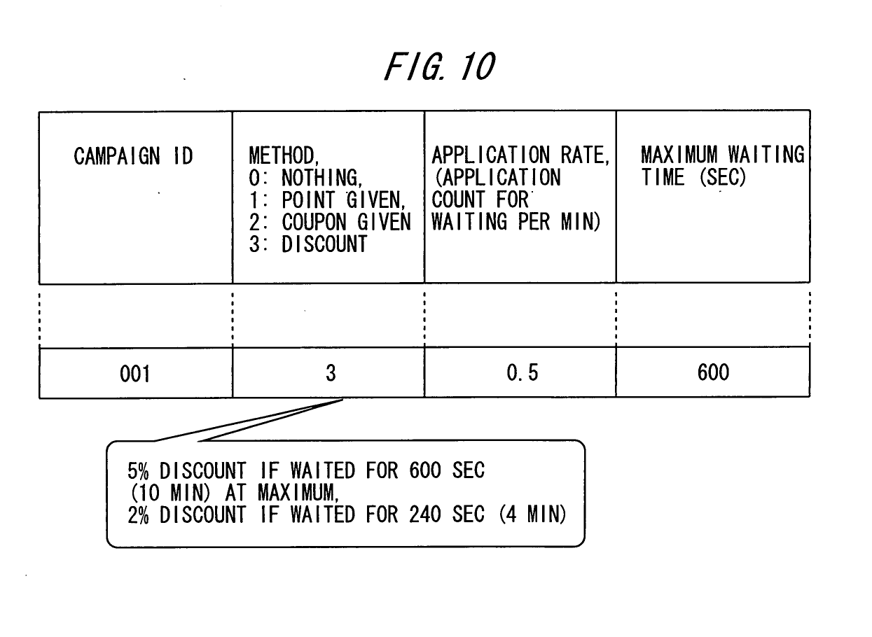

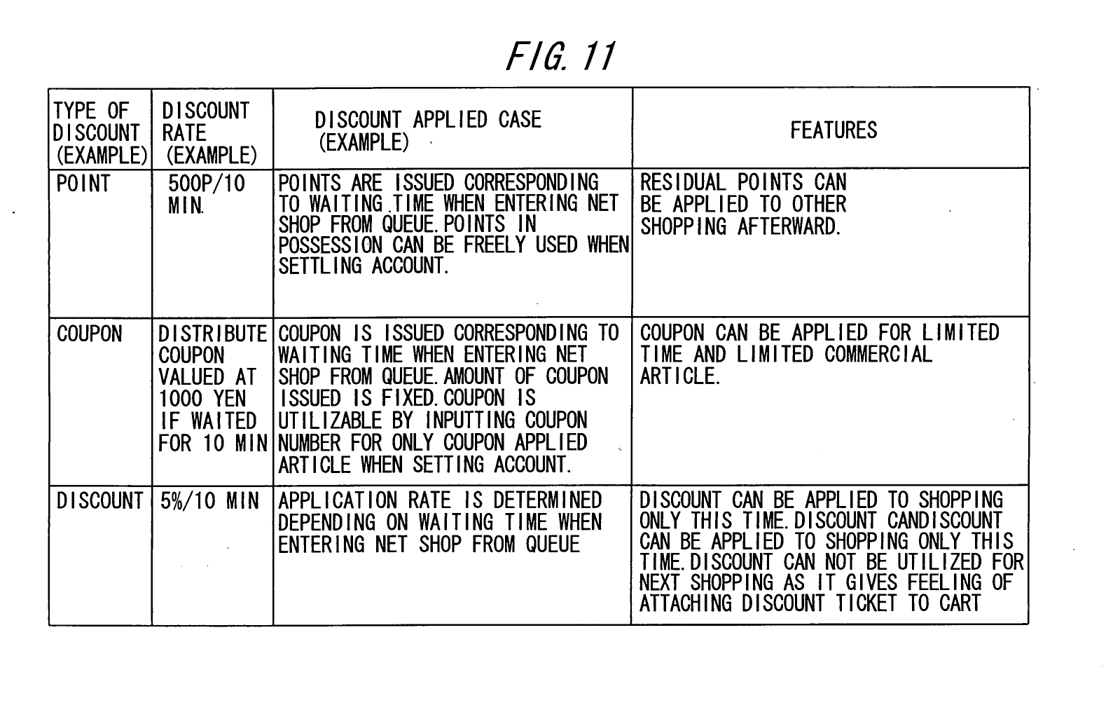

FIG. 9 is an explanatory chart of the queue DB. As shown in FIG. 9, a unique ID, creation date/time, a type of membership, waiting time and an applied campaign information are registered as the queue data in the queue DB in the embodiment. Note that the creation date/time is timestamped (recorded) on the unit of seconds. The type of membership is that when the client inputs the membership number, etc. at the access time, there are recorded the membership number and items of information such as a corporate member, an individual member, a special discount member, etc. who are identified by the membership numbers. The applied campaign number is information representing the incentive issued corresponding to the waiting time, and has a structure as shown in FIG. 10. As illustrated in FIG. 10, the applied campaign number in this example consists of items of information such as a campaign ID, a method, an application rate and maximum waiting time. It should be noted that the campaign ID is a number for identifying the campaign to which this incentive can be applied. The method is that an application method of the incentive to be issued is a number representing a point or a coupon or a discount, etc. shown in FIG. 11. The application rate is a numeric value representing a quantity (application count) of the incentive to be issued for the waiting time per minute. The maximum waiting time indicates an upper limit of the waiting time applied.

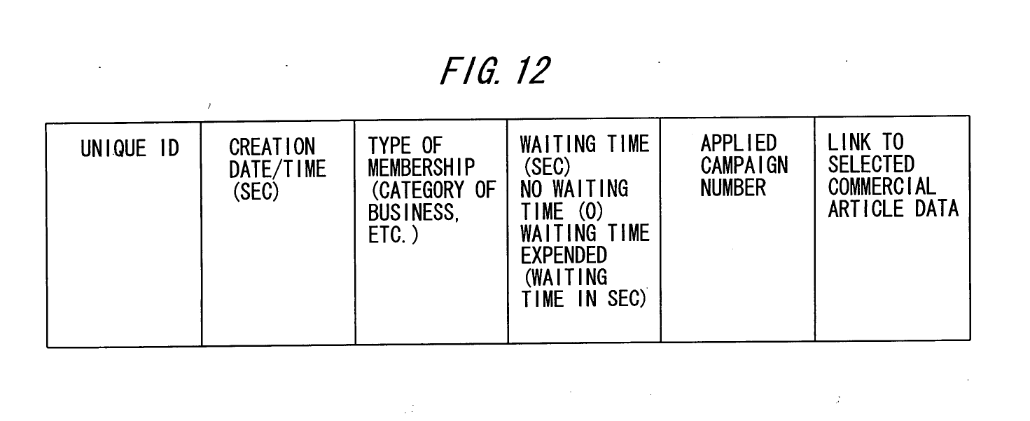

FIG. 12 is an explanatory chart of the shopping cart DB. As shown in FIG. 12, the shopping cart DB is stored with, as items of cart information in the embodiment, a unique ID, creation date/time, a type of membership, waiting time, an applied campaign number and selected commercial article information. This selected commercial article information is information about the commercial article selected to be put into the cart by the client, and retains pieces of information about a link to the page describing this commercial article, a price of the commercial article, a shipping charge, etc.

As explained above, in the embodiment, when receiving the request from the information device, if the server has the high load, the load of the server is controlled by setting the information device in the standby status, and the client is prevented from giving up the request by issuing the incentive corresponding to the waiting time.

<Others>

The invention is not limited to only the illustrative examples given above and can be, as a matter of course, modified in a variety of forms within the scope that does not deviate from the gist of the invention.

For example, the same effects as those in the embodiment discussed above can be acquired from configurations given in the following Notes. Further, the components thereof can be combined to the greatest possible degree.

What is claimed is:

1. A queue management device comprising:
a load monitor module monitoring a load of a server for providing a service in response to request information given from an information device;
a request allocation module notifying, when receiving the request information from the information device, the server of the request information if it proves from a result of monitoring that the load meets a predetermined condition, and, whereas if the load does not meet the predetermined condition, holding the request information and adding information about the information device to a queue;
an incentive issuing module notifying the information device added to the queue, of issuing an incentive corresponding to waiting time, and storing the information device and the incentive in a way that associates the information device and the incentive with each other; and
a request permission module excluding, if it proves from the result of monitoring that a new request is acceptable, the information about the information device from the queue in a predetermined order and notifying the server of the request information given from the information device.

2. A queue management device according to claim 1, wherein the incentive is a point, a discount or a coupon, which are usable in the service provided from the server.

3. A queue management device according to claim 1, wherein the information device added to the queue is notified of the waiting time and/or a waiting device count in accordance with the result of monitoring.

4. A queue management device according to claim 1, further comprising:
a storage module storing a queue-oriented content having a load lighter than that of the service provided by the server; and
a content providing module providing the queue-oriented content to the information device added to the queue.

5. A queue management device according to claim 4, wherein when notifying the information device of a guide of a Web site provided by the server as the queue-oriented content and receiving the request information based on the guide from the information device, the request permission module notifies the server of the request information based on the guide as a substitute for the on-hold request information on the occasion of excluding the information device from the queue.

6. A queue management method by which a computer executes steps of:
monitoring a load of a server for providing a service in response to request information given from an information device;
notifying, when receiving the request information from the information device, the server of the request information if it proves from a result of monitoring that the load meets a predetermined condition, and, whereas if the load does not meet the predetermined condition, holding the request information and adding information about the information device to a queue;
notifying the information device added to the queue, of issuing an incentive corresponding to waiting time, and storing the information device and the incentive in a way that associates the information device and the incentive with each other; and
excluding, if it proves from the result of monitoring that a new request is acceptable, the information about the information device from the queue in a predetermined order and notifying the server of the request information given from the information device.

7. A queue management method according to claim 6, wherein the incentive is a point, a discount or a coupon, which are usable in the service provided from the server.

8. A queue management method according to claim 6, wherein the information device added to the queue is notified of the waiting time and/or a waiting device count in accordance with the result of monitoring.

9. A queue management method according to claim 6, wherein the computer further executes a step of providing a queue-oriented content to the information device added to the queue from the storage module stored with the queue-oriented content having a load lighter than that of the service provided by the server.

10. A queue management method according to claim 9, wherein when notifying the information device of a guide of a Web site provided by the server as the queue-oriented content and receiving the request information based on the guide from the information device, the request permission module notifies the server of the request information based on the guide as a substitute for the on-hold request information on the occasion of excluding the information device from the queue.

11. A storage medium stored with a queue management program for, on a computer, executing steps of:
monitoring a load of a server for providing a service in response to request information given from an information device;
notifying, when receiving the request information from the information device, the server of the request information if it proves from a result of monitoring that the load meets a predetermined condition, and, whereas if the load does not meet the predetermined condition, holding the request information and adding information about the information device to a queue;
notifying the information device added to the queue, of issuing an incentive corresponding to waiting time, and storing the information device and the incentive in a way that associates the information device and the incentive with each other; and
excluding, if it proves from the result of monitoring that a new request is acceptable, the information about the information device from the queue in a predetermined order and notifying the server of the request information given from the information device.

12. A storage medium according to claim 11, wherein the incentive is a point, a discount or a coupon, which are usable in the service provided from the server.

13. A storage medium according to claim 11, wherein the information device added to the queue is notified of the waiting time and/or a waiting device count in accordance with the result of monitoring.

14. A storage medium according to claim 11, wherein the computer further executes a step of providing a queue-oriented content to the information device added to the queue from the storage module stored with the queue-oriented content having a load lighter than that of the service provided by the server.

15. A storage medium according to claim 14, wherein when notifying the information device of a guide of a Web site provided by the server as the queue-oriented content and receiving the request information based on the guide from the information device, the request permission module notifies the server of the request information based on the guide as a substitute for the on-hold request information on the occasion of excluding the information device from the queue.

16. A Web system comprising a server for providing a service in response to request information given from an information device, and a queue management device for restricting a request in accordance with a load of the server,
the queue management device comprising:
a load monitor module monitoring a load of a server for providing a service in response to request information given from an information device;
a request allocation module notifying, when receiving the request information from the information device, the server of the request information if it proves from a result of monitoring that the load meets a predetermined condition, and, whereas if the load does not meet the predetermined condition, holding the request information and adding information about the information device to a queue;
an incentive issuing module notifying the information device added to the queue, of issuing an incentive corresponding to waiting time, and storing the information device and the incentive in a way that associates the information device and the incentive with each other; and
a request permission module excluding, if it proves from the result of monitoring that a new request is acceptable, the information about the information device from the queue in a predetermined order and notifying the server of the request information given from the information device.

17. A Web system according to claim 16, wherein the incentive is a point, a discount or a coupon, which are usable in the service provided from the server.

18. A Web system according to claim 16, wherein the information device added to the queue is notified of the waiting time and/or awaiting device count in accordance with the result of monitoring.

19. A Web system according to claim 16, further comprising:
a storage module storing a queue-oriented content having a load lighter than that of the service provided by the server; and
a content providing module providing the queue-oriented content to the information device added to the queue.

20. A Web system according to claim 19, wherein when notifying the information device of a guide of a Web site provided by the server as the queue-oriented content and receiving the request information based on the guide from the information device, the request permission module notifies the server of the request information based on the guide as a substitute for the on-hold request information on the occasion of excluding the information device from the queue.
